(19) United States
(12) Patent Application Publication
(10) Pub. No.: US 2026/0296402 A1
(43) Pub. Date: Oct. 1, 2026

(54) MOVING BODY, MOVING BODY SYSTEM, MOVING BODY CONTROL METHOD, AND PROGRAM

(71) Applicant: HONDA MOTOR CO., LTD., Tokyo (JP)

(72) Inventors: Tadashi Sumioka, Wako-shi (JP); Takuya Tsujimura, Wako-shi (JP); Sho Takayanagi, Wako-shi (JP); Masato Yamagishi, Wako-shi (JP); Kazushi Akimoto, Wako-shi (JP)

(21) Appl. No.: 19/549,148

(22) Filed: Feb. 25, 2026

(30) Foreign Application Priority Data
Mar. 25, 2025 (JP) 2025-049675

(51) Int. Cl. B60W 30/02; B60W 10/20

(52) U.S. Cl. CPC B60W 30/02; B60W 10/20; B60W 2300/36; B60W 2510/205; B60W 2520/105; B60W 2552/40; B60W 2710/20

(57) ABSTRACT

A moving body, a moving body system, a moving body control method, and a program that enable slip-down fall avoidance is provided. A moving body includes a front wheel, a steering assist part that performs steering assist of the front wheel, a rear wheel, a swing assist unit that performs swing assist of the rear wheel, and a control device that changes a distribution ratio between the steering assist of the front wheel and the swing assist of the rear wheel in accordance with a vehicle speed and a road surface friction condition of the moving body.

### CROSS-REFERENCE TO RELATED APPLICATION

Priority is claimed on Japanese Patent Application No. 2025-049675, filed Mar. 25, 2025, the content of which is incorporated herein by reference.

### BACKGROUND OF THE INVENTION

### Field of the Invention

The present invention relates to a moving body, a moving body system, a moving body control method, and a program.

### Description of Related Art

In recent years, efforts to provide access to sustainable transport systems that also consider people in vulnerable positions among traffic participants have been intensifying. Toward the realization of this, research and development are being focused on further improving the safety and convenience of traffic through research and development related to preventive safety technology.

By the way, in two-wheeled vehicles, in preventive safety technology, fall prevention is an issue. For fall prevention of two-wheeled vehicles, for example, research and development are being conducted using an inverted pendulum model. In the inverted pendulum model, it has been shown that performing divergent component feedback control is the best control method in terms of stabilization.

Here, in a vehicle capable of front and rear wheel steering, when attempting to perform stabilization assist control, optimal control (LQR) is often used because it becomes a multi-input multi-output system. However, when the framework of optimal control is used, the divergent component feedback control configuration is lost, and therefore stabilization capability cannot be maximized.

On slippery road surfaces, it is difficult for a balanced vehicle to travel. In two-wheeled vehicles, the slip-down phenomenon is difficult to avoid even for skilled riders. Note that the slip-down phenomenon is a phenomenon in which, from a state where the grip between the tire and the road surface decreases (or is lost) and side slipping begins, the contact surface of the tire completely separates from the road surface and the vehicle falls over.

For such fall prevention, for example, a moving body has been proposed that can smoothly perform a transition from one state to the other state between a control state that stabilizes the posture of the vehicle body by tilting of the rear wheel with respect to the vehicle body and a control state that stops or suppresses the tilting of the rear wheel with respect to the vehicle body (for example, see Patent Document 1 (Japanese Patent Application Laid-Open No. 2024-46319) and Patent Document 2 (Japanese Patent Application Laid-Open No. 2024-46320)).

### SUMMARY OF INVENTION

However, in the conventional technology, behavior at the time of slip occurrence has not been reported, and fall avoidance capability at the time of slip occurrence has not been reported either.

The present invention has been made in view of the above-mentioned problems, and an object thereof is to provide a moving body, a moving body system, a moving body control method, and a program that enable slip-down fall avoidance. Additionally, by extension, it contributes to the development of sustainable transport systems.

### Solution to Problem

(1) In order to achieve the above object, a moving body according to one aspect of the present invention includes a front wheel, a steering assist part that performs steering assist of the front wheel, a rear wheel, a swing assist unit that performs swing assist of the rear wheel, and a control device that changes a distribution ratio between the steering assist of the front wheel and the swing assist of the rear wheel in accordance with the vehicle speed and road surface friction condition of the moving body.

(2) In the moving body according to the one aspect of (1) above, the control device may increase a ratio of the steering assist amount of the front wheel to the swing assist amount of the rear wheel with an increase in the vehicle speed.

(3) In the moving body according to the one aspect of (1) above, the steering assist amount of the front wheel may be increased as the road surface friction coefficient becomes larger.

(4) In the moving body according to one aspect of any one of (1) to (3) above, the control device may use, as a constraint condition, that the fall avoidance moment and the generated moment are equal when changing the distribution ratio between the steering assist of the front wheel and the swing assist of the rear wheel in accordance with the vehicle speed and road surface friction condition of the moving body.

(5) In the moving body according to one aspect of any one of (1) to (4) above, the control device may reduce a weight of a wheel having a higher tire friction circle limit margin of each wheel by using a μ utilization rate obtained from a side slip angle estimated value and an estimated road surface friction coefficient when changing the distribution ratio between the steering assist of the front wheel and the swing assist of the rear wheel in accordance with the vehicle speed and road surface friction condition of the moving body.

(6) In the moving body according to one aspect of any one of (1) to (5) above, the control device may change the distribution ratio between the steering assist of the front wheel and the swing assist of the rear wheel in accordance with the vehicle speed and road surface friction condition of the moving body by receiving as inputs the steering angle velocity of the steering of the front wheel and the swing velocity of the steering of the rear wheel and solving an optimal solution problem for these.

(7) In the moving body according to one aspect of any one of (1) to (5) above, the control device may change the distribution ratio between the steering assist of the front wheel and the swing assist of the rear wheel in accordance with the vehicle speed and road surface friction condition of the moving body by also receiving as input the acceleration/deceleration of the vehicle body and solving an optimal solution problem for the steering angle velocity of the steering of the front wheel, the swing velocity of the steering of the rear wheel, and the acceleration.

(8) In order to achieve the above object, a moving body system according to one aspect of the present invention includes a front wheel, a steering assist part that performs steering assist of the front wheel, a rear wheel, a swing assist unit that performs swing assist of the rear wheel, a sensor that detects a state of the moving body, and a control device that changes a distribution ratio between the steering assist of the front wheel and the swing assist of the rear wheel in accordance with the vehicle speed and road surface friction condition of the moving body.

(9) In order to achieve the above object, a moving body control method according to one aspect of the present invention is a control device that controls a moving body having a front wheel, a steering assist part that performs steering assist of the front wheel, a rear wheel, and a swing assist unit that performs swing assist of the rear wheel, wherein the control device changes a distribution ratio between the steering assist of the front wheel and the swing assist of the rear wheel in accordance with the vehicle speed and road surface friction condition of the moving body.

(10) In order to achieve the above object, a program according to one aspect of the present invention causes a computer that controls a moving body having a front wheel, a steering assist part that performs steering assist of the front wheel, a rear wheel, and a swing assist unit that performs swing assist of the rear wheel to change a distribution ratio between the steering assist of the front wheel and the swing assist of the rear wheel in accordance with the vehicle speed and road surface friction condition of the moving body.

According to the aspects of (1) to (10) above, slip-down fall avoidance becomes possible.

### BRIEF DESCRIPTION OF DRAWINGS

FIG. 1 is a diagram showing a configuration example of a moving body according to an embodiment.

FIG. 2 is a perspective view of a bike model of the embodiment.

FIG. 3 is a left side view and a rear view of the bike model of the embodiment.

FIG. 4 is a diagram showing an example of a four-bar linkage mechanism of the bike model of the embodiment.

FIG. 5 is a diagram showing the entirety of a control scheme of the embodiment.

FIG. 6 is a diagram showing an example of a breakdown of lateral acceleration generated when the front wheel is steered by 0.524 rad and the rear wheel is steered by 0.175 rad from a straight traveling state.

FIG. 7 is a flowchart of processing performed by the control device of the embodiment.

### DETAILED DESCRIPTION OF EMBODIMENTS

Hereinafter, embodiments of the present invention will be described with reference to the drawings. Note that in the drawings used for the following description, the scale of each member is appropriately changed in order to make each member a recognizable size.

Note that in all the drawings used to describe the embodiment, elements having the same functions are denoted by the same reference numerals, and repeated description thereof will be omitted.

In addition, the wording “based on XX” used in this specification means “based on at least XX,” and also includes cases based on other elements in addition to XX. In addition, the wording “based on XX” also includes a case based on an arithmetic operation or processing being performed on XX without being limited to a case in which XX is used directly. The term “XX” refers to any element (for example, any information).

### <Outline>

Two-wheeled vehicles may cause serious injury to a rider or the like when an accident such as a fall occurs. For this reason, many studies have been conducted on fall suppression of two-wheeled vehicles. For example, as a fall suppression technology during traveling, there exist an Anti-lock Brake System (ABS) capable of suppressing locking of wheels when a brake is gripped too strongly, and a Traction Control System (TCS) that prevents idling with respect to excessive driving force of a rear wheel, and these are applied to many mass-produced vehicles. These systems basically target slip suppression that occurs during braking or driving while traveling straight.

On the other hand, almost no research has been conducted on slip fall suppression during turning of two-wheeled vehicles. Therefore, in the embodiment, slip fall avoidance during turning in a state where the road surface friction coefficient is low on a bad road, for example, is realized.

### (Configuration Example)

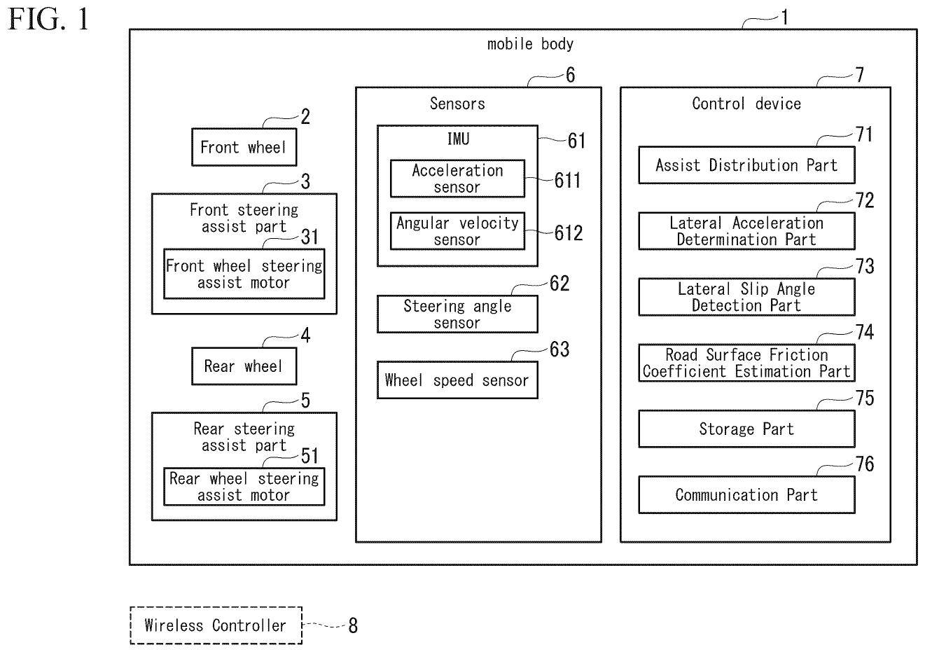

FIG. 1 is a diagram showing a configuration example of a moving body according to the present embodiment.

Note that in the following embodiment, a problem in verification that is difficult to verify with an actual machine from the viewpoint of safety is avoided by conducting experiments with an automatically driven two-wheeled vehicle.

Therefore, the moving body 1 in the following description has a motor (front wheel steering assist motor 31) capable of angular velocity control also on the steering of the front wheel in order to perform automatic driving by wireless communication. Further, the configuration is such that P_{1_y_d} (lateral movement amount of mass point) (characters after “_” represent subscripts) can be transmitted by the wireless controller 8. Furthermore, the configuration is such that driving/braking can be performed by transmitting a rear wheel drive torque instruction value by the wireless controller 8.

The moving body 1 includes, for example, a front wheel 2 that is a steered wheel, a front steering assist part 3, a rear wheel 4 that is a drive wheel, a rear steering assist part 5, a sensor 6, and a control device 7.

The sensor 6 includes, for example, an IMU 61, a steering angle sensor 62, and a wheel speed sensor 63. The IMU 61 includes, for example, an acceleration sensor 611 and an angular velocity sensor 612.

The control device 7 includes, for example, an assist distribution part 71, a lateral acceleration determination part 72, a lateral slip angle estimation part 73, a road surface friction coefficient estimation part 74, a storage part 75, and a communication part 76.

The moving body 1 is, for example, a two-wheeled vehicle, a saddle-type vehicle. The moving body 1 also has a seat on which a driver (not shown) sits, a front body continuous with the front of a floor portion, a rear body continuous with the rear of the floor portion, and the like, which are not shown.

The front steering assist part 3 includes a front wheel steering assist motor 31. The front wheel steering assist motor is driven and controlled in accordance with control by the control device 7.

The rear steering assist part 5 includes a rear wheel swing motor 51. The rear wheel swing motor 51 is driven and controlled in accordance with control by the control device 7.

The acceleration sensor 611 detects, for example, acceleration in each of the front-rear direction of the moving body 1, the vertical direction of the moving body 1, and the left-right direction of the moving body 1.

The angular velocity sensor 612 detects, for example, angular velocity in each of the pitch direction of the moving body 1, the roll direction of the moving body 1, and the yaw direction of the moving body 1.

The steering angle sensor 62 detects, for example, the steering angle of the front wheel 2 and the swing angle of the rear wheel 4.

The wheel speed sensor 63 detects, for example, the wheel speed of the front wheel 2 and the wheel speed of the rear wheel 4.

The control device 7 controls the moving body 1 using the motor torque acquired from the wireless controller 8 and P_{1_y_d}.

The assist distribution part 71 changes the distribution ratio of the front steering assist part 3 and the rear steering assist part 5 in accordance with the vehicle speed and road surface friction condition (estimated road surface friction coefficient) of the moving body 1. Note that the distribution method and the like will be described later.

The lateral acceleration determination part 72 uses P_{1_y} and P·_{1_y} estimated by the road surface friction coefficient estimation part 74 and P_{1_y_d} acquired from the wireless controller 8, and outputs a fall avoidance moment u_{DCM} to the assist distribution part 71 using, for example, DCM (Divergent-Component-of-Motion) feedback (for example, see Reference Document 1).

Reference Document 1: G. Romualdi, S. Dafarra, Y Hu, and D. Pucci, “A benchmarking of DCM based architectures for position and velocity controlled walking of humanoid robots”, IEEE-RAS 18th International Conference on Humanoid Robots, 2018, p 966-973

The lateral slip angle estimation part 73 calculates, for example, a lateral slip angle using the x-axis component and y-axis component of the vehicle speed V. The lateral slip angle estimation part 73 obtains μ⁻ based on the result obtained by the road surface friction coefficient estimation part 74. More specifically, the lateral slip angle estimation part 73 obtains a posture angle estimated value based on the IMU 61 output, and corrects the obtained posture angle estimated value. Further, the lateral slip angle estimation part 73 inputs the front and rear wheel steering angles and the wheel speeds of the front and rear wheels to vehicle body dynamics to obtain a model. The lateral slip angle estimation part 73 estimates the vehicle speed using the obtained model and the corrected angular velocity. The lateral slip angle estimation part 73 obtains the lateral slip angle using the estimated vehicle speed and a correction term of the gravitational acceleration vector. The lateral slip angle estimation part 73 obtains, for example, using an E2PMD (an Equivalent Two-Point Mass Decomposition)-LIP (linear inverted pendulum) model or the like, the lateral movement amount P_{1_y} of the mass of m₁ and its first derivative P·_{1_y}, and outputs the obtained P_{1_y} and P·_{1_y} to the lateral acceleration determination part 72. Further, the lateral slip angle estimation part 73 outputs the parameters of the E2PMD-LIP and the velocity Vₒₓ to the assist distribution part 71.

The road surface friction coefficient estimation part 74 calculates, for example, lateral acceleration using the wheel speed detected by the wheel speed sensor 63, the vehicle body roll angular velocity detected by the angular velocity sensor 612, and the vehicle body lateral velocity and yaw rate calculated from the geometrical relationship. Next, the road surface friction coefficient estimation part 74 converts the acceleration detected by the acceleration sensor 611 into lateral actual measured acceleration transformed to ground coordinates, and estimates the road surface friction coefficient μ⁻ (where the overbar “⁻” represents an estimated value) using a road surface friction model based on the calculated lateral acceleration and the converted lateral actual measured acceleration. The road surface friction coefficient estimation part 74 outputs the estimated road surface friction coefficient μ⁻ to the assist distribution part 71. Note that the estimated value of the road surface friction coefficient may be, for example, estimation using a camera, or a slipperiness switch or the like may be prepared and the rider himself/herself may operate and select when the rider thinks that the road surface seems slippery.

The storage part 75 stores algorithms, models, formulas, threshold values, and the like used by each unit of the control device 7.

The communication part 76 acquires a torque command value and a target value P_{1_y_d} of P_{1_y} from the wireless controller 8.

### (Bike Model)

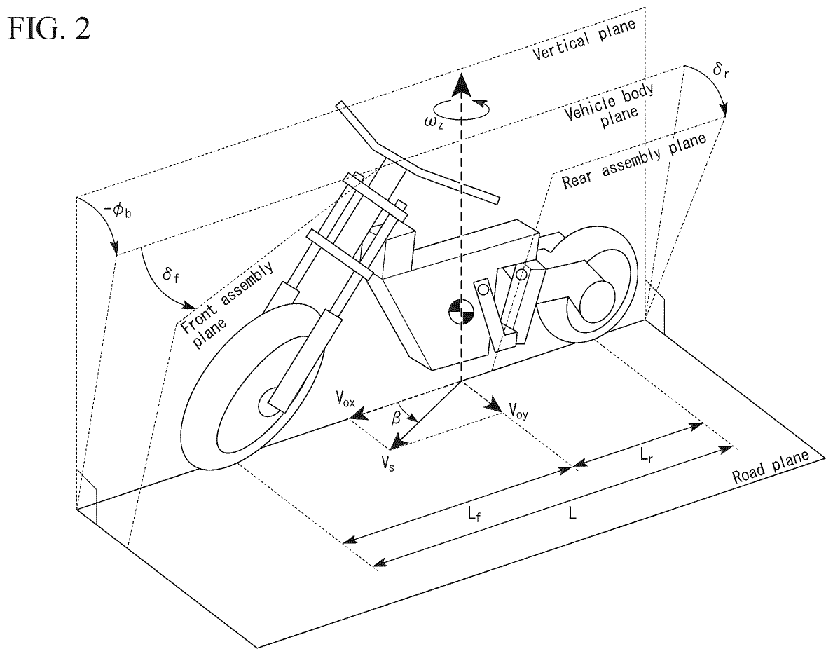

Next, the bike model used in the present embodiment will be described with reference to FIGS. 2 to 4.

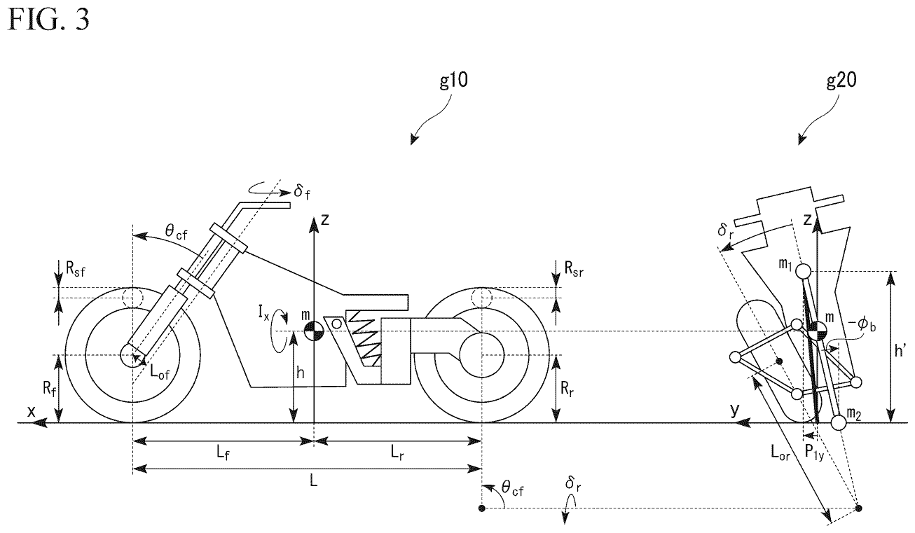

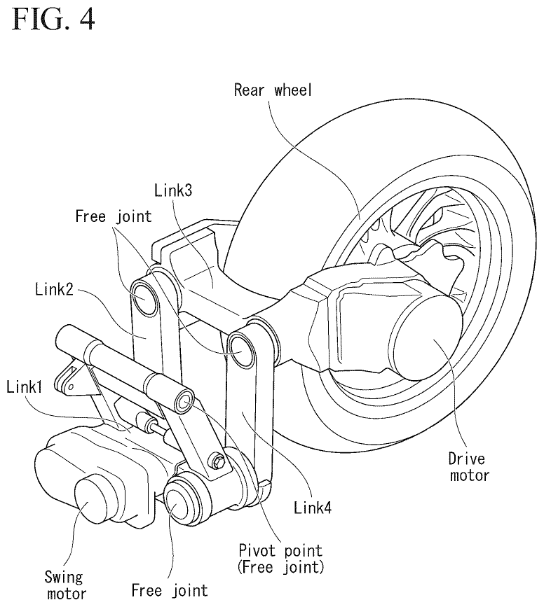

FIG. 2 is a perspective view of the bike model of the present embodiment. FIG. 3 is a left side view and a rear view of the bike model of the present embodiment. FIG. 4 is a diagram showing an example of a four-bar linkage mechanism of the bike model of the present embodiment.

Note that the model described with reference to FIGS. 2 to 4 is a multi-input multi-output inverted pendulum model. In this model, the inputs are the command value of the front wheel steering assist motor and the command value of the rear wheel swing motor. Further, the outputs are the inverted pendulum lateral movement amount (≈vehicle body roll angle) and the inverted pendulum lateral movement velocity (≈vehicle body roll angular velocity).

Each symbol in the bike model shown in FIGS. 2 and 3 will be described.

The ground direction is taken as the x-axis direction, the height direction of the moving body 1 is taken as the z direction, and the width direction of the vehicle body is taken as the y direction.

L is the distance (m) between the front wheel and the rear wheel, L_{f} is the distance (m) from the center (or center of gravity) position of L to the front wheel, and Lᵣ is the distance (m) from the center (or center of gravity) position of L to the rear wheel. L_{of} is the fork offset (m).

m is the total mass (kg) of the moving body 1. h is the height (m) from the center of gravity. Iₓ is the total roll inertia (kgm²) with respect to the center of gravity. g is the gravitational acceleration (m/s²).

δ_{f} is the rotation angle (rad) of the steering of the front wheel 2. δᵣ is the rotation angle (rad) of the steering of the rear wheel 4.

R_{f} is the wheel radius (m) of the front wheel 2, Rᵣ is the wheel radius (m) of the rear wheel 4, R_ₛ_f is the cross-sectional radius of the front wheel 2, and Rₛ_r is the cross-sectional radius (m) of the rear wheel.

θ_{cf} is the caster angle (rad) of the front wheel 2, and θ_{cr} is the caster angle (rad) of the rear wheel 4.

β is the angle (rad) of Vs with respect to Vₒₓ. Vs is a vector component of the longitudinal velocity Vₒₓ generated around the center of gravity calculated from the wheel angular velocity of the front wheel 2 or the rear wheel 4, and the lateral velocity V_{oy} generated around the center of gravity calculated from the wheel angular velocity of the front wheel 2 or the rear wheel 4.

As shown in FIG. 4, the rear wheel swing motor 51 is connected to the rear wheel 4 via Link 1 to Link 4. The length of Link 3 is longer than the length of Link 1, and Link 2 and Link 4 have the same length. The vehicle body is fixed to Link 1, and the rear wheel is fixed to Link 3. Link 1 is connected to the vehicle body at a pivot point. δr is the rear wheel swing angle, which is the same as the roll angle of the rear wheel with respect to the vehicle body. Although θ_{cr} and Lₒᵣ are very large, δᵣ can also be considered as steering of the rear wheel 4 in a broad sense based on the same definition as the front wheel 2.

### (Equivalent Two-Point Mass Decomposition Inverted Model)

In the equivalent two-point mass decomposition inverted model, h′ is the height (m) of the inverted pendulum mass point and is expressed by the following formula (1). m₁ is the inverted pendulum mass point in the equivalent two-point mass decomposition inverted model and is expressed by the following formula (2), and m₂ is the ground mass point in the equivalent two-point mass decomposition inverted model and is expressed by the following formula (3).

$${h}^{′} = h + \frac{{I}_{X}}{mh} \qquad ( 1 )$$

$${m}_{1} = \frac{mh}{{h}^{′}} \qquad ( 2 )$$

$${m}_{2} = ( 1 - \frac{h}{{h}^{′}} ) m \qquad ( 3 )$$

Further, the equivalent two-point mass decomposition inverted model can be expressed by the following formula (4).

$$\frac{d}{dt} [ \begin{matrix}{P}_{{1}_{y}} \\ {\dot{P}}_{{1}_{y}}\end{matrix} ] = [ \begin{matrix}0 & 1 \\ {ω}^{2} & 0\end{matrix} ] [ \begin{matrix}{P}_{{1}_{y}} \\ {\dot{P}}_{{1}_{y}}\end{matrix} ] + [ \begin{matrix}0 \\ - 1\end{matrix} ] u \qquad ( 4 )$$

In formula (4), P_{1_y} is the lateral movement amount of the m1 mass point. ω is the natural frequency in the equivalent two-point mass decomposition inverted model and can be expressed by the following formula (5), and u is the lateral acceleration input in the equivalent two-point mass decomposition inverted model and can be expressed by the following formula (6).

$$ω = \sqrt{( 1 - \frac{m}{{m}_{1} {h}^{′}} {R}_{{S}_{eq}} ) \frac{g}{{h}^{′}}} \qquad ( 5 )$$

$$u = {u}_{v} + {u}_{v 0} \qquad ( 6 )$$

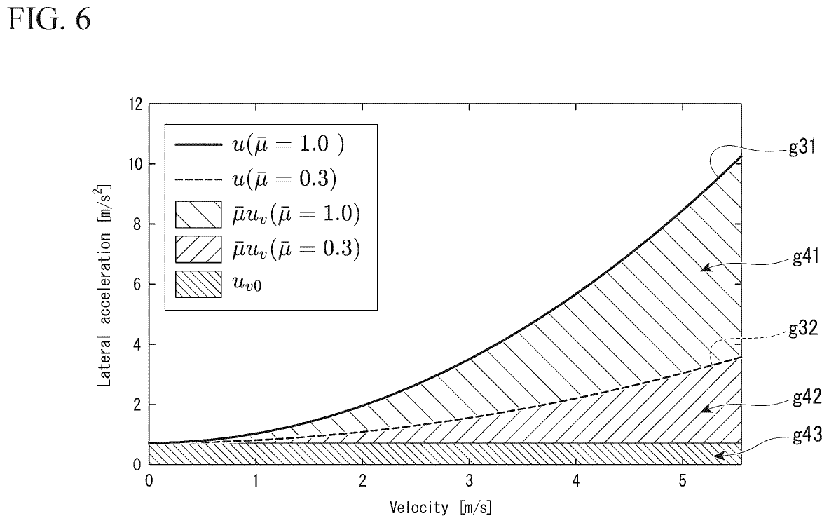

Thus, in the present embodiment, the lateral acceleration input u in the equivalent two-point mass decomposition inverted model is decomposed into a term uᵥ and a term uᵥ₀ and used. The term uᵥ is a term of lateral acceleration that is generated in accordance with the vehicle speed and depends on the velocity received from the inertial coordinate system. The term uᵥ₀ is a term of lateral acceleration that is generated even at zero vehicle speed and is generated by steering of the front and rear wheels without depending on the vehicle speed. Note that when the vehicle speed is large, as will be described later with reference to FIG. 6, since the influence of the lateral weight is large, the influence of the term uᵥ becomes dominant. Further, as will be described with reference to FIG. 6, when the vehicle speed is large, the influence of the road surface friction coefficient is also large.

In formula (5), R_S_eq is the equivalent cross-sectional radius of the front and rear wheels and can be expressed by the following formula (7).

$${R}_{{S}_{eq}} = \frac{{L}_{r}}{L} {R}_{{S}_{j}} + \frac{{L}_{f}}{L} {R}_{{S}_{r}} \qquad ( 7 )$$

Further, the term uᵥ of lateral acceleration depending on the velocity received from the inertial coordinate system can be expressed by the following formula (8).

$${u}_{v} = {\dot{V}}_{oy} + {V}_{ox} {ω}_{z} \qquad ( 8 )$$

In formula (8), V_{oy} and ω_{z} are the lateral velocity and yaw rate generated around the center of gravity, and when ignoring slip, they can be calculated as the following formulas (9) and (10), respectively. Note that V· is the first derivative of V and is acceleration.

$${V}_{oy} = \frac{{L}_{r} {V}_{ox} cos {θ}_{cf}}{L} {δ}_{f} + \frac{{L}_{f} {V}_{ox} cos {θ}_{cr}}{L} {δ}_{r} \qquad ( 9 )$$

$${ω}_{2} = \frac{{V}_{ox} cos {θ}_{cf}}{L} {δ}_{f} - \frac{{V}_{ox} cos {θ}_{cr}}{L} {δ}_{r} \qquad ( 10 )$$

Further, in formula (8), Vₒₓ is the longitudinal velocity generated around the center of gravity calculated from the wheel angular velocity of the front wheel 2 or the rear wheel 4.

The lateral acceleration term uᵥ₀ generated by steering of the front and rear wheels without depending on the vehicle speed in formula (6) can be expressed as the following formula (11).

$${u}_{v 0} = {C}_{{δ}_{f}} {δ}_{f} + {C}_{{δ}_{r}} {δ}_{r} \qquad ( 11 )$$

In formula (11), C_{δ}_i (where i is f or r) is the following formula (12).

$${C}_{{δ}_{i}} = \frac{g {L}_{i} ( {L}_{oí} - {R}_{í} sin {θ}_{ci} )}{{h}^{′} {m}_{1} L} ( {m}_{2} + \frac{{mR}_{{S}_{eq}}}{{h}^{′}} - \frac{m {R}_{{S}_{i}} sin {θ}_{ci}}{{L}_{oi} - {R}_{i} sin {θ}_{cf}} ) \qquad ( 12 )$$

In formula (12), since Lₒᵣ becomes a nonlinear function depending on δᵣ, C_δᵣ becomes a nonlinear function with respect to δᵣ.

Furthermore, in order to realize divergent component feedback control, the lateral acceleration input u needs to satisfy the following formula (13) (for example, see Reference Document 2).

Reference Document 2: T. Sumioka, K. Akimoto, T. Tsujimura, S. Takayanagi, K. Fukushimaand T. Nose, “Rider Cooperative Control of Rear-Wheel-Swing Motorcycle Based on Divergent Component of Motion”, IEEE ROBOTICS AND AUTOMATION LETTERS, VOL. 9, NO. 1, pp. 223-230, JANUARY 2024

$${u}_{DCM} = {K}_{ξ} ( {P}_{{1}_{y}} - {P}_{{1}_{{y}_{d}}} ) + \frac{{K}_{ξ}}{ω} ( {\dot{P}}_{{1}_{y}} - {\dot{P}}_{{1}_{{y}_{d}}} ) … \qquad ( 13 )$$

In formula (13), here K_{ξ} is the divergent component feedback gain, and in the present embodiment, it was set as K_{ξ}=2ω² so that the poles become multiple roots. Further, P_{1_y_d} and P·_{1_y_d} are target values of P_{1_y} and P·_{1_y}, respectively.

Further, as described above, the moving body 1 has a motor capable of angular velocity control also on the steering of the front wheel as shown in FIGS. 2 and 3 in order to perform automatic driving by wireless communication. Further, the configuration is such that the target value P_{1_y_d} can be transmitted by the wireless controller 8. Note that in the present example, P·_{1_y_d} was set to 0. Furthermore, the configuration is such that driving or braking can be performed by transmitting a rear wheel drive torque instruction value by the wireless controller 8.

### (Control Method)

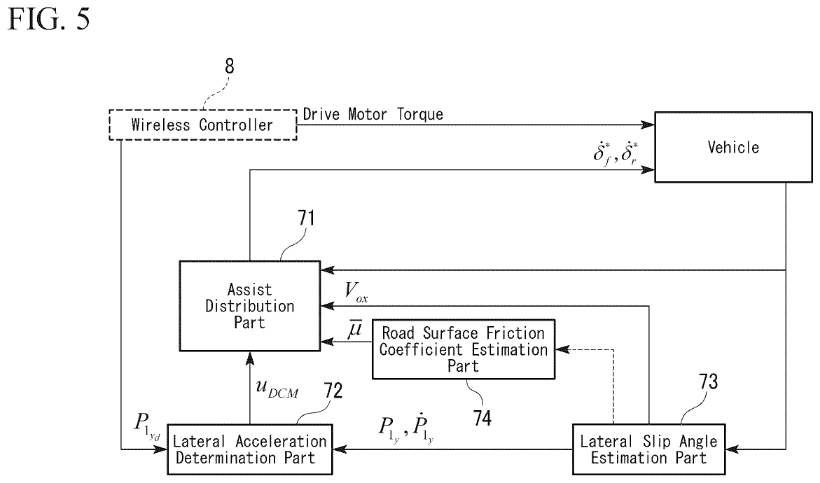

Hereinafter, processing performed by the assist distribution part 71, the lateral acceleration determination part 72, the lateral slip angle estimation part 73, and the road surface friction coefficient estimation part 74 will be described with reference to FIG. 5. FIG. 5 is a diagram showing the entirety of a control scheme of the present embodiment.

### I. Road Surface Friction Coefficient Compensation

The above-mentioned uᵥ₀ is lateral acceleration generated by contact point movement and center-of-gravity movement based on the law of conservation of angular momentum that occur during front and rear wheel steering, and therefore is a term that does not depend on road surface friction. On the other hand, the above-mentioned uᵥ is lateral acceleration generated due to the force acting between the tire and the road surface during traveling and, therefore, is originally a term that depends on road surface friction.

Therefore, in the present embodiment, formula (6) is redefined as the following formula (14).

$$u = \overline{μ} {u}_{v} + {u}_{v 0} \qquad ( 14 )$$

In formula (14), μ⁻ is a variable that changes depending on the road surface friction condition. When θ_{cr}≈π/2 rad, uᵥ is hardly affected by rear wheel steering, and the vehicle speed and front wheel steering amount become dominant. Further, uᵥ₀ is dominated by the rear wheel steering amount.

FIG. 6 is a diagram showing an example of a breakdown of lateral acceleration generated when the front wheel is steered by 0.524 rad and the rear wheel is steered by 0.175 rad from a straight traveling state. The horizontal axis is the velocity (m/s), and the vertical axis is the acceleration (m/s²).

Line g31 is the change in acceleration with respect to velocity of u when the road surface friction coefficient μ⁻=1.0. Line g32 is the change in acceleration with respect to velocity of u when μ⁻=0.3.

Area g41 is μ⁻uᵥ when μ⁻=1.0. Area g42 is μ⁻uᵥ when μ⁻=0.3. Area g43 is uᵥ₀.

As shown in FIG. 6, in the extremely low speed region, uᵥ₀, that is, the rear wheel steering amount is dominant, but as the vehicle speed increases, μ⁻uᵥ, that is, the front wheel steering amount becomes dominant.

Further, when μ⁻ decreases from 1.0 to 0.3, the ratio of μ⁻uᵥ to uᵥ₀ changes, and it can be seen from FIG. 6 that the wheel that should be assisted differs depending on the vehicle speed and road surface friction condition.

Therefore, in the present embodiment, the assist amounts of the front wheel and the rear wheel are controlled.

For example, the assist distribution part 71 increases the ratio of the steering assist amount of the front wheel to the swing assist amount of the rear wheel with an increase in the vehicle speed because the front wheel steering amount becomes dominant as the vehicle speed increases as shown in FIG. 6.

Further, for example, the assist distribution part 71 increases the front wheel steering assist amount as the road surface friction coefficient μ⁻ becomes larger (closer to 1) because the ratio of μ⁻uᵥ to uᵥ₀ changes.

### II. Optimal Distribution of Front and Rear Wheels

As shown in FIG. 5, when the inputs of the present system are δ_{f} and δᵣ and the outputs are P_{1_y} and P·_{1_y}, it becomes a two-input two-output system, and therefore a method of stabilization by Linear Quadratic Regulator (LQR) can be considered.

However, if a controller is configured by LQR, the divergent component feedback control configuration, which is the best regulator in terms of stabilization of an inverted pendulum model with input constraint conditions, cannot be maintained (or it is difficult to find an LQR weight matrix corresponding to the divergent component feedback configuration).

Therefore, in the embodiment, while maintaining the divergent component feedback configuration (see Reference Document 3), it is possible to calculate the optimal assist distribution to the front and rear wheels in consideration of the above-mentioned vehicle speed and road surface friction condition.

Reference Document 3: T. Sugihara, “Standing stabilizability and stepping maneuver in planar bipedalism based on the best COM-ZMP regulator”, 2009 IEEE International Conference on Robotics and Automation, 2009, pp. 1966-1971.

From formula (9), \dot{V}_{oy} can be calculated as the following formula (15).

$${\dot{V}}_{oy} = \frac{\partial {V}_{oy}}{\partial {δ}_{f}} {δ}_{f} + \frac{\partial {V}_{oy}}{\partial {δ}_{r}} {\dot{δ}}_{r} + \frac{\partial {V}_{oy}}{\partial {V}_{ox}} {\dot{V}}_{ox} \qquad ( 15 )$$

From formula (15), formula (14) can be rewritten as the following formula (16).

$$u = \overline{μ} \frac{\partial {V}_{oy}}{\partial {δ}_{f}} {\dot{δ}}_{f} + \overline{μ} \frac{\partial {V}_{oy}}{\partial {δ}_{r}} {\dot{δ}}_{r} + \overline{μ} \frac{\partial {V}_{oy}}{\partial {V}_{ox}} {\dot{V}}_{ox} + \overline{μ} {V}_{ox} {ω}_{z} + {u}_{v 0} \qquad ( 16 )$$

The fourth term and the fifth term on the right side of formula (16) are combined and denoted as u′ as in the following formula (17).

$${μ}^{′} = \overline{μ} {V}_{ox} {ω}_{z} + {u}_{v 0} \qquad ( 17 )$$

Since u′ is a nonlinear function with respect to δᵣ, it is considered to express it as a function of δ·_{f} and δ·ᵣ by performing Taylor approximation around the point one control cycle before as in the following formula (18).

$$\begin{matrix}{u}^{′} ≃ {μ}_{p}^{′} + \frac{\partial {u}^{′}}{\partial {δ}_{f}} ( {\dot{δ}}_{j} - {\dot{δ}}_{{f}_{p}} ) + \frac{\partial {u}^{′}}{\partial {δ}_{r}} ( {\dot{δ}}_{r} - {\dot{δ}}_{{r}_{p}} ) \\ = {μ}_{p}^{′} + \frac{\partial {u}^{′}}{\partial {δ}_{f}} Δ t {δ}_{f} + \frac{\partial {u}^{′}}{\partial {δ}_{r}} Δ t {\dot{δ}}_{r}\end{matrix} \qquad ( 18 )$$

In formula (18), u′ₚ, δ_{f_p}, and δ_{r_p} are u′, δ_{f}, and δᵣ one control cycle before. Further, Δt is the control cycle. From formulas (16), (17), and (18), u can be approximated as the following formula (19).

$$u ≃ ( \overline{μ} \frac{\partial {V}_{oy}}{\partial {δ}_{f}} + \overline{μ} \frac{\partial {V}_{oy}}{\partial {δ}_{f}} Δ t ) {\dot{δ}}_{f} + ( \overline{μ} \frac{\partial {V}_{oy}}{\partial {δ}_{r}} + \overline{μ} \frac{\partial {V}_{oy}}{\partial {δ}_{r}} Δ t ) + \overline{μ} \frac{\partial {V}_{oy}}{\partial {V}_{ox}} {\dot{V}}_{ox} + {u}_{p}^{′} \qquad ( 19 )$$

It is considered to solve the optimization problem of the following formulas (20) to (22) with the constraint condition that the right side of formula (19) and the right side of formula (13) match. Note that the meaning of formula (20) is that it is solved as an optimization problem in which the sum of squares of the steering angle velocity of the front wheel 2 and the swing velocity of the rear wheel 4 is minimized. Further, formula (21) is a constraint condition, which is that the fall avoidance moment matches the generated moment.

$$arg {min}_{{δ}_{f} , {δ}_{r}} {w}_{f} {\dot{δ}}_{f}^{2} + {w}_{r} {\dot{δ}}_{r}^{2} \qquad ( 20 )$$

$$\begin{matrix}s . t . ( \overline{μ} \frac{\partial {V}_{oy}}{\partial {δ}_{f}} + \overline{μ} \frac{\partial {u}^{′}}{\partial {δ}_{f}} Δ t ) {\dot{δ}}_{f} + ( \overline{μ} \frac{\partial {V}_{oy}}{\partial {δ}_{r}} + \overline{μ} \frac{\partial {u}^{′}}{\partial {δ}_{r}} Δ t ) {\dot{δ}}_{r} \\ = {u}_{DCM} - {u}_{p}^{′} - μ \frac{\partial {V}_{oy}}{\partial {V}_{ox}} {\dot{V}}_{ox}\end{matrix} \qquad ( 21 )$$

$$\begin{matrix}{w}_{f} > 0 \\ {w}_{r} > 0\end{matrix} \qquad ( 22 )$$

In formulas (20) to (22), w_{f} and wᵣ are weight variables, and basically they are set as w_{f}=1 and wᵣ=1, or it is conceivable to reduce the weight of the wheel having a higher tire friction circle limit margin of each wheel by using the friction circle usage rate obtained from the lateral slip angle estimated value and the road surface friction coefficient estimated value. Note that when the friction circle currently being used is taken as radius R_now, for example, and the friction circle limit R_lim (>R_now) determined by the contact load and the road surface friction coefficient is assumed, the friction circle usage rate is a rate expressed by R_now/R_lim, and represents how much the dynamic friction force of the road surface can be utilized.

Since the above optimization problem is a linear quadratic programming problem, the optimal solutions (δ⁻)*_{f} and (δ⁻)*ᵣ, which are the steering angle velocity of the steering of the front wheel and the swing velocity of the steering of the rear wheel, can be obtained without iterative calculation as in the following formulas (23) and (24).

$${\dot{δ}}_{f}^{*} = \frac{{w}_{r} ( {u}_{DCM} - {u}_{p}^{′} - \overline{μ} \frac{\partial {V}_{oy}}{\partial {V}_{ox}} {\dot{V}}_{ox} ) ( \overline{μ} \frac{\partial {V}_{oy}}{\partial {δ}_{f}} + \overline{μ} \frac{\partial {u}^{′}}{\partial {δ}_{f}} Δ t )}{{w}_{r} {( \overline{μ} \frac{\partial {V}_{oy}}{\partial {δ}_{r}} + \overline{μ} \frac{\partial {u}^{′}}{\partial {δ}_{r}} Δ t )}^{2} + {{w}_{r} ( \overline{μ} \frac{\partial {V}_{oy}}{\partial {δ}_{f}} + \overline{μ} \frac{\partial {u}^{′}}{\partial {δ}_{f}} Δ t )}^{2}} \qquad ( 23 )$$

$${\dot{δ}}_{r}^{*} = \frac{{w}_{f} ( {u}_{DCM} - {u}_{p}^{′} - \overline{μ} \frac{\partial {V}_{oy}}{\partial {V}_{ox}} {\dot{V}}_{ox} ) ( \overline{μ} \frac{\partial {V}_{oy}}{\partial {δ}_{r}} + \overline{μ} \frac{\partial {u}^{′}}{\partial {δ}_{r}} Δ t )}{{w}_{f} {( \overline{μ} \frac{\partial {V}_{oy}}{\partial {δ}_{r}} + \overline{μ} \frac{\partial {u}^{′}}{\partial {δ}_{r}} Δ t )}^{2} + {{w}_{r} ( \overline{μ} \frac{\partial {V}_{oy}}{\partial {δ}_{f}} + \overline{μ} \frac{\partial {u}^{′}}{\partial {δ}_{f}} Δ t )}^{2}} \qquad ( 24 )$$

Since formulas (23) and (24) include the road surface friction coefficient μ⁻ and the vehicle speed Vₒₓ, by calculating the formulas, they are distributed so as to mainly use the front wheel when the vehicle speed is at a certain high level, and to mainly use the rear wheel when the vehicle speed is low. For example, in formulas (23) and (24), V_{oy} is the lateral vehicle speed, and as the vehicle speed increases, the lateral G increases, and for example, in formula (9), the caster angle θ_{cr} is approximately 90 degrees and cos θ_{cr} is almost zero and the second term is almost zero, and the control of the front wheel becomes dominant. Note that depending on the structure of the assist unit, the caster angle θ_{cr} is not approximately 90 degrees, but changes in the same manner as the caster angle θ_{cf}.

Additionally, in formulas (23) and (24), the distribution ratio according to the vehicle speed and road surface friction condition is determined by the term μ⁻(∂V_{oy}/∂δᵢ)+(∂u′/∂δᵢ)Δt, and an efficient input is selected under the evaluation function of input minimization.

Note that when the rear wheel swing assist is not used and automatic driving is performed only with the front wheel, the following formula (25) is obtained by setting the second term on the right side of formula (19) to 0 and solving again with respect to δ·_{f}.

$${\dot{δ}}_{f} = \frac{{u}_{DCM} - {u}_{p}^{′} - \overline{μ} \frac{\partial {V}_{oy}}{\partial {V}_{ox}} {\dot{V}}_{ox}}{\overline{μ} \frac{\partial {V}_{oy}}{\partial {δ}_{f}} + \overline{μ} \frac{\partial {u}^{′}}{\partial {δ}_{f}} Δ t} \qquad ( 25 )$$

Note that although it is preferable to assist both the front wheel and the rear wheel as described above, the method of the present embodiment can also be applied to only the front wheel assist.

When assisting only the front wheel, as described above, when automatic driving is performed only with the front wheel, the following formula (25) is obtained by setting the second term on the right side of formula (19) to 0 and solving again with respect to δ·_{f}, and it is used. When assisting only the front wheel, the control device 7 controls using δ·_{f} obtained in this way. Note that in this way, in the case of assist of only one wheel, assist distribution to the front and rear wheels is not performed. In the case of assist of only the front wheel, formula (25) is used.

On the other hand, when the front wheel steering assist is not used and automatic driving is performed only with the rear wheel, δ·ᵣ is obtained by setting the first term on the right side of formula (19) to 0 and solving again with respect to δ·ᵣ.

### (Processing Flow)

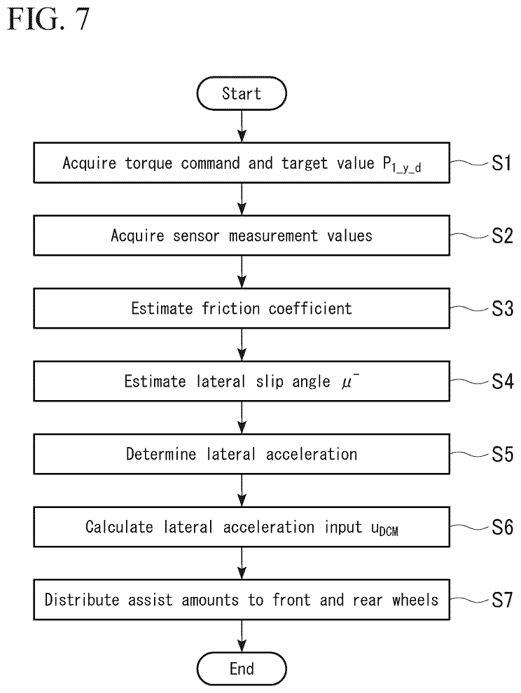

FIG. 7 is a flowchart of processing performed by the control device of the present embodiment.

(Step S1) The communication part 76 acquires a torque command and a target value P_{1_y_d} from the wireless controller 8.

(Step S2) The communication part 76 acquires the steering angle of the front wheel 2, the steering angle of the rear wheel 4, the wheel speed of the front wheel 2, the wheel speed of the rear wheel 4, and the measured value of the IMU 61 from the sensor 6.

(Step S3) The lateral slip angle estimation part 73 obtains, for example, using an E2PMD-LIP model or the like, the lateral movement amount P_{1_y} of the mass of m₁ and its first derivative P·_{1_y} using the detected values of the sensor 6 acquired.

(Step S4) The road surface friction coefficient estimation part 74 estimates, for example, the road surface friction coefficient μ⁻ based on the result obtained by the lateral slip angle estimation part 73.

(Step S5) The lateral acceleration determination part 72 uses P_{1_y} and P·_{1_y} estimated by the lateral slip angle estimation part 73 and P_{1_y_d} acquired from the wireless controller 8, and obtains, for example, using DCM feedback, the fall avoidance moment u_DCM that is the lateral acceleration input.

(Step S6) The assist distribution part 71 changes the distribution ratio of the front steering assist part 3 and the rear steering assist part 5 in accordance with the vehicle speed and road surface friction condition (estimated road surface friction coefficient) of the moving body 1. The assist distribution part 71 obtains the optimal solutions (δ·)*_{f} and (δ·)*ᵣ using, for example, the parameters of the E2PMD-LIP model in the lateral slip angle estimation part 73 and the velocity Vₒₓ, the μ⁻ estimated by the road surface friction coefficient estimation part 74, the detected values detected by the sensor 6, the fall avoidance moment u_{DCM} that is the lateral acceleration input obtained by the lateral acceleration determination part 72, and formulas (23) and (24).

The control device 7 controls the vehicle based on the obtained optimal solutions (δ·)*_{f} and (δ·)*ᵣ and the torque command value.

Further, the control device 7 repeats the processing of steps S1 to S6, for example, at every predetermined time.

### (Evaluation Results)

Using the above-mentioned method, as a result of performing evaluations by actual vehicle experiments on DRY road surface automatic driving, jump traveling, low road traveling (for example, traveling on an artificial skating rink (road surface friction coefficient of approximately 0.3), wet road surfaces, etc.), it was confirmed that slip-down fall avoidance was possible.

As described above, in the present embodiment, control is performed by optimally distributing the front and rear wheel assist distribution in accordance with the vehicle speed and road surface condition. Further, in the present embodiment, the ratio of the steering assist amount of the front wheel to the swing assist amount of the rear wheel is increased with an increase in the vehicle speed. Furthermore, in the present embodiment, the front wheel steering assist amount is increased as the road surface friction coefficient becomes larger.

As a result, according to the present embodiment, slip-down fall avoidance becomes possible by performing optimal steering assist while considering the slipperiness of the road surface, the traveling vehicle speed, and the tire friction circle limit. Note that the tire friction circle limit can be obtained using, for example, a value estimated by the lateral slip angle estimation part 73 or the road surface friction coefficient estimation part 74. Note that the friction circle is a representation of the limit of tire gripping force as a circle, and the idea is that the force acting in the acceleration or deceleration direction and the force acting in the left and right cornering direction are represented as vectors, and they cannot exceed the friction circle. In the present embodiment, the weight is set so as to use the steering angle (or swing) of the wheel that has a margin in the friction circle limit. Note that the weight is set to a small value for the one to be mainly used.

### Modified Example

When the control device 7 distributes and controls the front wheel steering assist and the rear wheel swing assist, the acceleration/deceleration of the vehicle body may also be used as an input.

In this case, the optimization problem for obtaining δ·_{f}, δ·ᵣ, and \dot{V}·ₒₓ is as follows in the following formulas (26) to (28). Note that the meaning of formula (26) is that it is solved as an optimization problem in which the sum of squares of the steering angle velocity of the front wheel 2, the swing velocity of the rear wheel 4, and the vehicle speed is minimized. Further, formula (27) is a constraint condition, which is that the fall avoidance moment matches the generated moment.

$$arg {min}_{{\dot{δ}}_{f} , {\dot{δ}}_{r}} {w}_{f} {\dot{δ}}_{f}^{2} + {w}_{r} {\dot{δ}}_{r}^{2} + {w}_{{a}_{x}} {\dot{V}}_{ox}^{2} \qquad ( 26 )$$

$$\begin{matrix}s . t . ( \overline{μ} \frac{\partial {V}_{oy}}{\partial {δ}_{f}} + \overline{μ} \frac{\partial {u}^{′}}{\partial {δ}_{f}} Δ t ) {\dot{δ}}_{f} + ( \overline{μ} \frac{\partial {V}_{oy}}{\partial {δ}_{r}} + \overline{μ} \frac{\partial {u}^{′}}{\partial {δ}_{r}} Δ t ) {\dot{δ}}_{r} \\ + μ \frac{\partial {V}_{oy}}{\partial {V}_{ox}} {\dot{V}}_{ox} \\ = {u}_{DCM} - {u}_{p}^{′}\end{matrix} \qquad ( 27 )$$

$$\begin{matrix}{w}_{f} > 0 \\ {w}_{r} > 0 \\ {w}_{{a}_{s}} > 0\end{matrix} \qquad ( 28 )$$

The solutions of the optimization problem of formulas (26) to (28) are the following formulas (29) to (31). Thus, according to the modified example, control can be performed by adding the increase/decrease in vehicle speed in addition to the steering angle velocity of the front wheel and the swing velocity of the rear wheel.

$${\dot{δ}}_{f}^{*} = \frac{{w}_{r} {w}_{{a}_{x}} ( {u}_{DCM} - {u}_{p}^{′} ) ( \overline{μ} \frac{\partial {V}_{oy}}{\partial {δ}_{f}} + \overline{μ} \frac{\partial {u}^{′}}{\partial {δ}_{f}} Δ t )}{{w}_{f} {w}_{r} A + {w}_{r} {w}_{{a}_{x}} B + {w}_{{a}_{x}} {w}_{f} C} \qquad ( 29 )$$

$${\dot{δ}}_{r}^{*} = \frac{{w}_{f} {w}_{{a}_{x}} ( {u}_{DCM} - {u}_{p}^{′} ) ( \overline{μ} \frac{\partial {V}_{oy}}{\partial {δ}_{r}} + \overline{μ} \frac{\partial {u}^{′}}{\partial {δ}_{r}} Δ t )}{{w}_{f} {w}_{r} A + {w}_{r} {w}_{{a}_{x}} B + {w}_{{a}_{x}} {w}_{f} C} \qquad ( 30 )$$

$${\dot{V}}_{ox}^{*} = \frac{{w}_{f} {w}_{r} ( {u}_{DCM} - {u}_{p}^{′} ) \overline{μ} \frac{\partial {V}_{oy}}{\partial {V}_{ox}} {\dot{V}}_{ox}}{{w}_{f} {w}_{r} A + {w}_{r} {w}_{{a}_{x}} {B}_{{a}_{x}} B + {w}_{{a}_{x}} {w}_{f} C} \qquad ( 31 )$$

Note that in formulas (29) to (31), A, B, and C are the following formula (32).

$$\begin{matrix}A = {( \overline{μ} \frac{\partial {V}_{oy}}{\partial {V}_{ox}} {\dot{V}}_{ox} )}^{2} , \\ B = {( \overline{μ} \frac{\partial {V}_{oy}}{\partial {δ}_{f}} + \overline{μ} \frac{\partial {u}^{′}}{\partial {δ}_{f}} Δ t )}^{2} , \\ C = {( \overline{μ} \frac{\partial {V}_{oy}}{\partial {δ}_{r}} + \overline{μ} \frac{\partial {u}^{′}}{\partial {δ}_{r}} Δ t )}^{2}\end{matrix} \qquad ( 32 )$$

Note that the above-mentioned method can also be applied by solving for acceleration. Furthermore, “front wheel steering velocity” and “acceleration” may be solved, or “rear wheel steering velocity” and “acceleration” may be solved. Even in such cases, assist control is possible (control is possible with the same theory depending on the variation of the vehicle-mounted actuator) in the same manner as in the above-described embodiments, examples, and modified examples.

Here, the reason for assisting both the front wheel and the rear wheel will be further explained.

In the case of a two-wheeled vehicle, the wheel capable of generating a large assist force differs depending on the vehicle specifications and vehicle speed, and in particular, if assist control is continued with the less efficient wheel, it results in waste of energy, and in the worst case, there is a possibility of failure due to motor overload.

Therefore, it is necessary to optimally calculate and control the assist amount in accordance with the vehicle speed and road surface condition as in the present embodiment.

Thus, in the present embodiment, both the front wheel and the rear wheel are assisted, and furthermore, the assist amounts of the front wheel and the rear wheel are distributed and controlled.

As described above, even when the acceleration/deceleration of the vehicle body is also used as an input, control is performed by optimally distributing the front and rear wheel assist distribution in accordance with the vehicle speed and road surface condition. Even in the modified example, the ratio of the steering assist amount of the front wheel to the swing assist amount of the rear wheel may be increased with an increase in the vehicle speed. Furthermore, even in the modified example, the front wheel steering assist amount may be increased as the road surface friction coefficient becomes larger.

As a result, according to the modified example, slip-down fall avoidance becomes possible by performing optimal steering assist while considering the slipperiness of the road surface, the traveling vehicle speed, and the tire friction circle limit. Further, according to the present embodiment, continuous traveling has become possible by performing optimal front and rear wheel assist even on low (friction coefficient) road surfaces. According to the present embodiment, front wheel steering (self-steering) is naturally generated in accordance with the vehicle body roll angle.

Note that the model and the like used by the control device 7 described above may be stored by the storage part 75, may be placed on the cloud, or may be stored by a server or the like via a network.

Note that the above-mentioned method and configuration can also be applied to a stabilization method using a gyro, a stabilization method using an auto stand, or the like.

Note that in the above-mentioned example, an example of performing evaluation or the like using a vehicle that travels unmanned using the wireless controller 8 has been described, but the configuration and method of the present embodiment can also be applied to a manned vehicle. In the case of a manned vehicle, the instruction from the wireless controller 8 corresponds to, for example, the accelerator amount or throttle amount operated by the driver. Note that P_{1_y_d} corresponds to an operation intended for the driver's weight transfer.

Note that a program for realizing all or part of the functions of the control device 7 in the present invention may be recorded on a computer-readable recording medium, and all or part of the processing performed by the control device 7 may be performed by causing a computer system to read and execute the program recorded on this recording medium. The “computer system” mentioned herein includes an operating system (OS) and hardware such as peripherals. The “computer system” may include a WWW system including a homepage provision environment (or display environment). The “computer-readable recording medium” refers to a portable medium such as a flexible disk, a magneto-optical disc, a ROM, or a CD-ROM and a storage device such as a hard disk incorporated into a computer system. The “computer-readable recording medium” also includes a medium that holds a program for a predetermined time, such as a volatile memory (RAM) in a computer system serving as a server or a client when a program is transmitted via a network such as the Internet or a communication line such as a telephone line.

Alternatively, some or all of these components may be realized by hardware (including circuitry) such as LSI (Large Scale Integration), ASIC (Application Specific Integrated Circuit), FPGA (Field-Programmable Gate Array), GPU (Graphics Processing Unit), or SOC (System On Chip), or may be realized by cooperation between software and hardware.

The program may be transmitted from a computer system storing the program in a storage device or the like to another computer system via a transmission medium or using carrier waves in the transmission medium. The “transmission medium” for transmitting a program is a medium having a function of transmitting information such as a network (a communication network) such as the Internet or a communication circuit (a communication line) such as a telephone circuit. The program may be a program for realizing some of the aforementioned functions. The program may be a so-called differential file (a differential program) which can realize the aforementioned functions in combination with another program stored in advance in the computer system.

While the mode for carrying out the present invention has been described above with reference to an embodiment, the present invention is not limited to the embodiment, and various modifications and substitutions can be performed thereon without departing from the gist of the present invention.

### <Supplementary Note>

The control device changes the distribution ratio between the steering assist of the front wheel and the swing assist of the rear wheel in accordance with the vehicle speed and road surface friction condition of the moving body by receiving as inputs the steering angle velocity of the front wheel and the swing velocity, and solving the steering angular acceleration of the front wheel and an optimal solution problem for these.

### EXPLANATION OF REFERENCES

1 Moving body
2 Front wheel
3 Front steering assist part
4 Rear wheel
5 Rear steering assist part
6 Sensor
7 Control device
61 IMU
62 Steering angle sensor
63 Wheel speed sensor
611 Acceleration sensor
612 Angular velocity sensor
71 Assist distribution part
72 Lateral acceleration determination part
73 Lateral slip angle estimation part
74 Road surface friction coefficient estimation part
75 Storage part
76 Communication part

What is claimed is:

1. A moving body comprising:
a front wheel;
a steering assist part that performs steering assist of the front wheel;
a rear wheel;
a swing assist unit that performs swing assist of the rear wheel; and
a control device that changes a distribution ratio between the steering assist of the front wheel and the swing assist of the rear wheel in accordance with a vehicle speed and a road surface friction condition of the moving body.

2. The moving body according to claim 1, wherein
the control device increases a ratio of a steering assist amount of the front wheel to a swing assist amount of the rear wheel with an increase in the vehicle speed.

3. The moving body according to claim 1, wherein
the steering assist amount of the front wheel is increased as a road surface friction coefficient becomes larger.

4. The moving body according to claim 1, wherein
the control device uses, as a constraint condition, that a fall avoidance moment and a generated moment are equal when changing the distribution ratio between the steering assist of the front wheel and the swing assist of the rear wheel in accordance with the vehicle speed and the road surface friction condition of the moving body.

5. The moving body according to claim 1, wherein
the control device reduces a weight of a wheel having a higher tire friction circle limit margin of each wheel by using a utilization rate obtained from a side slip angle estimated value and an estimated road surface friction coefficient when changing the distribution ratio between the steering assist of the front wheel and the swing assist of the rear wheel in accordance with the vehicle speed and the road surface friction condition of the moving body.

6. The moving body according to claim 1, wherein
the control device changes the distribution ratio between the steering assist of the front wheel and the swing assist of the rear wheel in accordance with the vehicle speed and the road surface friction condition of the moving body by receiving, as inputs, a steering angle velocity of steering of the front wheel and a swing velocity of steering of the rear wheel and solving an optimal solution problem for these.

7. The moving body according to claim 1, wherein
the control device changes the distribution ratio between the steering assist of the front wheel and the swing assist of the rear wheel in accordance with the vehicle speed and the road surface friction condition of the moving body by also receiving, as an input, acceleration/deceleration of a vehicle body and solving an optimal solution problem for a steering angle velocity of steering of the front wheel, a swing velocity of steering of the rear wheel, and an acceleration.

8. A moving body system comprising:
a front wheel;
a steering assist part that performs steering assist of the front wheel;
a rear wheel;
a swing assist unit that performs swing assist of the rear wheel;
a sensor that detects a state of a moving body; and
a control device that changes a distribution ratio between the steering assist of the front wheel and the swing assist of the rear wheel in accordance with a vehicle speed and a road surface friction condition of the moving body.

9. A moving body control method for a control device that controls a moving body having a front wheel, a steering assist part that performs steering assist of the front wheel, a rear wheel, and a swing assist unit that performs swing assist of the rear wheel, wherein
the control device changes a distribution ratio between the steering assist of the front wheel and the swing assist of the rear wheel in accordance with a vehicle speed and a road surface friction condition of the moving body.

10. A program that causes a computer that controls a moving body having a front wheel, a steering assist part that performs steering assist of the front wheel, a rear wheel, and a swing assist unit that performs swing assist of the rear wheel to change a distribution ratio between the steering assist of the front wheel and the swing assist of the rear wheel in accordance with a vehicle speed and a road surface friction condition of the moving body.
